(19) United States
(12) Patent Application Publication
(10) Pub. No.: US 2013/0235321 A1
(43) Pub. Date: Sep. 12, 2013

(54) METHOD OF PRODUCING FILM SUBSTRATE

(71) Applicant: FUJITSU FRONTECH LIMITED, Tokyo (JP)

(72) Inventor: Takahiro HIRANO, Tokyo (JP)

(73) Assignee: Fujitsu Frontech Limited, Tokyo (JP)

(21) Appl. No.: 13/869,379

(22) Filed: Apr. 24, 2013

Related U.S. Application Data
(63) Continuation of application No. PCT/JP2010/069922, filed on Nov. 9, 2010.

(51) Int. Cl. G02F 1/1341

(52) U.S. Cl. CPC G02F 1/1341
USPC 349/190

(57) ABSTRACT

A method of producing a film substrate includes forming a sealing part for sealing a liquid crystal material between a first substrate and a second substrate into a shape having an outward projecting liquid crystal material injection port of the sealing part and cutting the first substrate and the second substrate into a shape having outward projecting parts opposite to the liquid crystal material injection port, in which the forming of the sealing part forms the liquid crystal material injection port of the sealing part on a cutting line of the cutting of the first substrate and the second substrate.

### CROSS-REFERENCE TO RELATED APPLICATION

This application is a continuation application of International Application PCT/JP2010/069922 filed on Nov. 9, 2010 and designated the U.S., the entire contents of which are incorporated herein by reference.

### FIELD OF THE INVENTION

The embodiments described herein are related to a method of producing a film substrate having flexibility.

### BACKGROUND OF THE INVENTION

According to conventional techniques, a liquid crystal panel has a sealing part formed for sealing a liquid crystal material between two opposite substrates, and a liquid crystal is injected into the sealing part (see, for example, Patent Documents 1 through 3).

FIG. 6 is a plan view showing a mother film 20 for explaining a conventional method of producing a film substrate.

FIG. 7 explains a conventional step of injecting a liquid crystal.

FIG. 8 is a sectional view along line B-B in FIG. 7.

Two first substrates 11 shown in FIG. 7 are formed from a mother film 20 shown in FIG. 6 by, for example, performing a cutting process along cutting lines 14.

A sealing part 13 that seals a liquid crystal material 15 is formed into a rectangle (of four sides 13a through 13d) having a liquid crystal material injection port 13e projecting outwards on the mother film 20. At the tip of the liquid crystal material injection port 13e, there is an opening 13f.

Each of the cutting lines 14 for cutting out the first substrate 11 from the mother film 20 is rectangular. Part of the tip of the liquid crystal material injection port 13e of the sealing part 13 is cut along the cutting line 14. Note that the cutting lines 14 are virtual lines, as indicated by double-dot dash lines, and are not visible.

A second substrate 12 shown in FIG. 7 is cut out from a mother film that is similar to the mother film 20, and is adhered to the first substrate 11 in such a manner that transparent electrodes 11a and 12a are opposite to each other. The first substrate 11 and the second substrate 12 adhered to each other are decompressed until, for example, the sealing part 13 becomes a vacuum, and under that condition, the liquid crystal material injection port 13e is inserted into the liquid crystal material 15 of a liquid crystal holding part 16. Thereafter, when the decompression in the sealing part 13 is cancelled, the liquid crystal material 15 is injected into the sealing part 13.

Patent Document 1: Japanese Laid-open Patent Publication No. 2002-049043

Patent Document 2: Japanese Laid-open Patent Publication No. 2002-072915

Patent Document 3: Japanese Laid-open Patent Publication No. 2000-310784

### BRIEF SUMMARY OF THE INVENTION

A method of producing a film substrate disclosed herein includes forming a sealing part for sealing a liquid crystal material between a first substrate and a second substrate into a shape having an outward projecting liquid crystal material injection port of the sealing part, and cutting the first substrate and the second substrate into a shape having outward projecting parts opposite to the liquid crystal material injection port, in which the forming of the sealing part forms the liquid crystal material injection port of the sealing part on a cutting line of the cutting of the first substrate and the second substrate.

### BRIEF DESCRIPTION OF THE SEVERAL VIEWS OF THE DRAWING

FIG. 1 is a plan view showing a mother film illustrated for explaining a sealing part forming step and a substrate cutting step according to an embodiment;

FIG. 2 is an enlarged view showing part A of FIG. 1;

FIG. 3 is a plan view showing a first substrate and a second substrate before a liquid crystal is injected according to an embodiment;

FIG. 4 explains a liquid crystal injection step according to an embodiment;

FIG. 5 is a plan view showing the first substrate and the second substrate after a liquid crystal has been injected according to an embodiment;

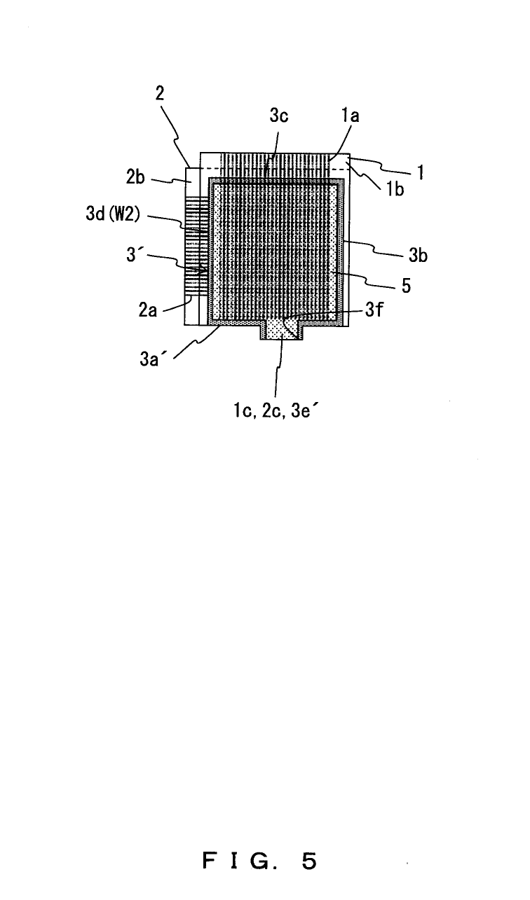

FIG. 6 is a plan view showing a mother film for explaining a conventional method of producing a film substrate;

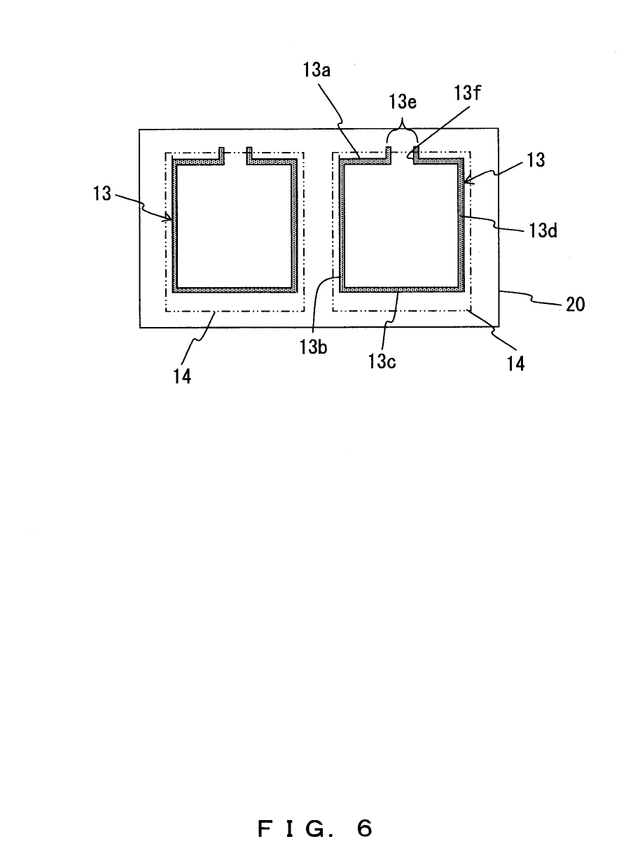

FIG. 7 shows a conventional liquid crystal injection step;

and

FIG. 8 is a sectional view along line B-B.

### DETAILED DESCRIPTION OF THE INVENTION

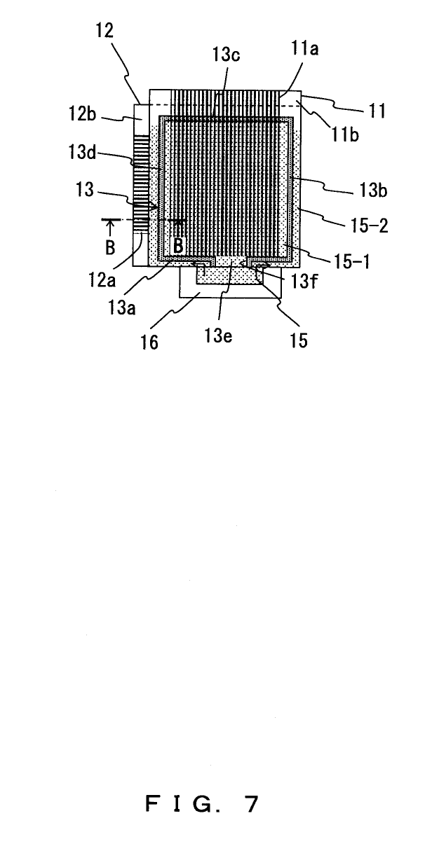

The sealing part 13 shown in FIG. 7 is cut out together with the first substrate 11 and the second substrate 12 along the cutting line 14 in the liquid crystal material injection port 13e in the projecting direction by a cutter or the like. Accordingly, there is a narrow margin between the first substrate 11 (second substrate 12) and an injection port forming side 13a, which is the side on which the liquid crystal material injection port 13e is provided among the four sides (13a through 13d) of the rectangle of the sealing part 13.

Accordingly, when the liquid crystal material 15 is injected into the sealing part 13, it is not only injected into the sealing part 13 through the liquid crystal material injection port 13e (a liquid crystal material 15-1), but part of it flows to the peripheries of the first substrate 11 and the second substrate 12 (a liquid crystal material 15-2).

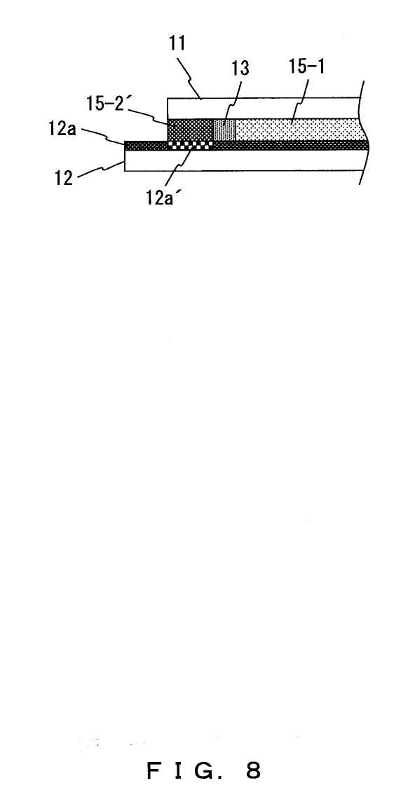

As described above, the liquid crystal material 15-2 that has flowed to the peripheries of the first substrate 11 and the second substrate 12 deteriorates as shown in FIG. 8 (15-2′), and corrodes, for example, the transparent electrode 12a of the second substrate 12 (12a′).

As described above, when a liquid crystal material has flowed to peripheries of a sealing part for sealing a liquid crystal material, electrodes are corroded. Thus, a step of washing a panel is necessary for eliminating a liquid crystal material that has flowed to peripheries of a sealing part. Further, a liquid crystal material that has flowed to peripheries of a sealing part cannot be utilized, giving rise to the need for more liquid crystal material than is actually injected into a sealing part.

Hereinafter, explanations will be given for a method of producing a film substrate according to an embodiment by referring to the drawings.

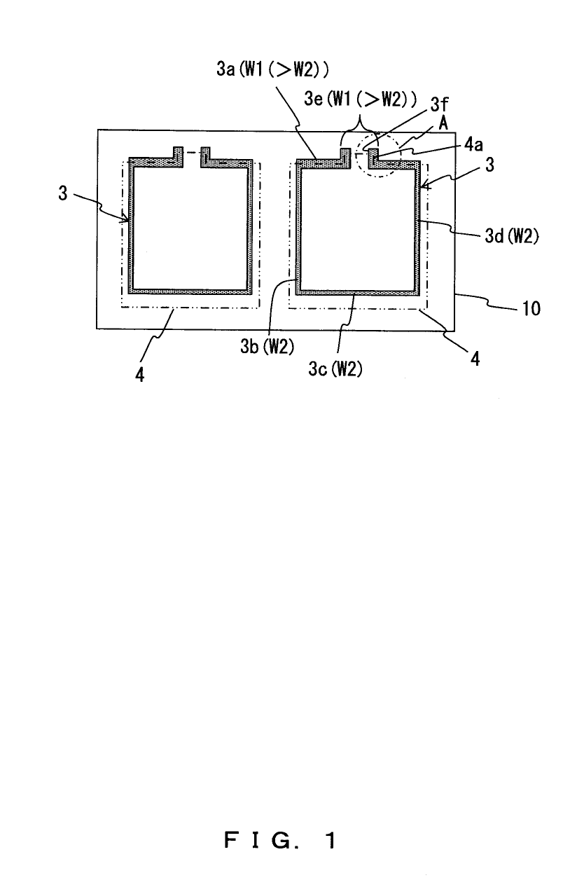

FIG. 1 is a plan view showing a mother film 10 illustrated for explaining a sealing part forming step and a substrate cutting step according to an embodiment.

First, explanations will be given for the sealing part forming step and the substrate cutting step.

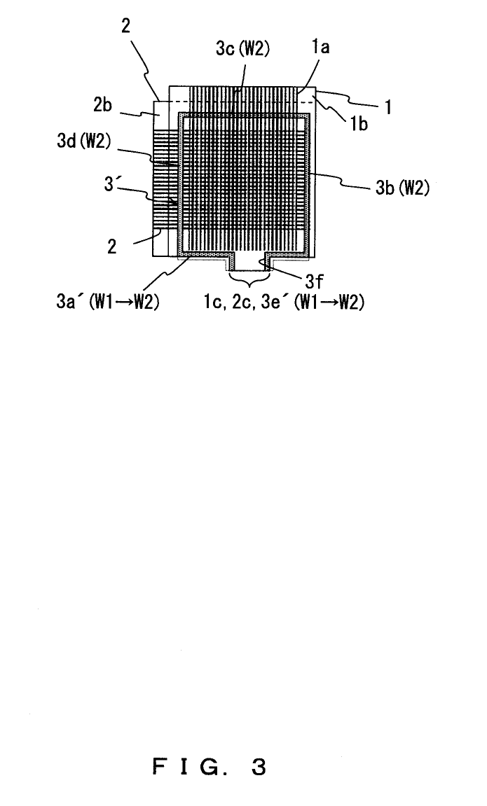

In the sealing part forming step, a sealing part 3 for sealing a liquid crystal material 5 between a first substrate 1 and a second substrate 2 shown in FIG. 3 is formed into a rectangle (such as a square, an oblong, or the like) having a liquid crystal material injection port 3e projecting outwards. This step will be explained later in more detail.

In the substrate cutting step, the first substrate 1 and the second substrate 2 are cut out so that they become rectangles respectively having outward projecting parts 1c and 2c that are opposite to the liquid crystal material injection port 3e.

Note that a rectangle as a shape of the sealing part 3, the first substrate 1, and the second substrate 2 is only an example, and thus they can employ other shapes.

The mother film 10 shown in FIG. 1 is, for example, a flexible transparent film made of plastic. Two (an example of at least one) of the first substrates 1 shown in FIG. 3 are formed by cutting the mother film 10 by performing a die-cut process or the like along a cutting line.

Each of the cutting lines 4, which indicate the shape for die cutting to be performed on the first substrate 1 and second substrate 2, depicts a rectangle having an outward projecting part 4a that is opposite to the liquid crystal material injection port 3e of the sealing part 3. The cutting lines 4 are virtual lines, as depicted by double-dot dash lines, and do not have to be visible lines.

When the sealing part 3 is to be formed, the sealing part 3 is formed so that it is a rectangle having the liquid crystal material injection port 3e projecting outwards (sealing part forming step). At the projecting tip of the liquid crystal material injection port 3e, an opening 3f is provided.

In the sealing part forming step, the liquid crystal material injection port 3e of the liquid crystal material injection port 3e and an injection port forming side 3a, which is one side of four sides 3a through 3d of the sealing part 3, are formed along the cutting line 4. Accordingly, part of the liquid crystal material injection port 3e and the injection port forming side 3a in the width direction are cut out in the substrate cutting step.

Note that it is also possible to employ a configuration in which the injection port forming side 3a is not formed entirely on the cutting line 4, but a portion (for example, an area of 2 mm in length or longer) extending at least to liquid crystal material injection port 3e on both sides of the liquid crystal material injection port 3e is formed on the cutting line 4.

The liquid crystal material injection port 3e alone may also be formed on the cutting line 4.

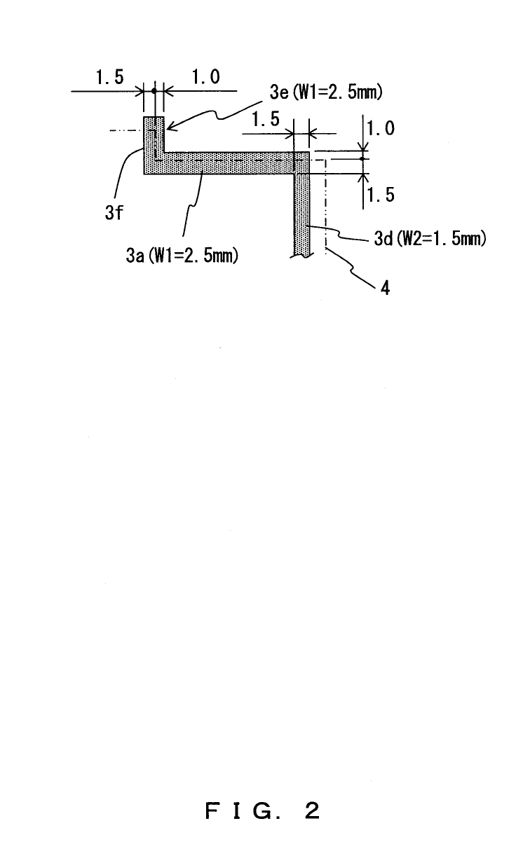

As shown in FIG. 2, which is an enlarged view showing part A in FIG. 1, in the sealing part forming step, sealing width W1 of the liquid crystal material injection port 3e and the injection port forming side 3a located on the cutting line 4 is greater than sealing width W2 of the three sides 3b through 3d, i.e., the sides other than the injection port forming side 3a.

In the present embodiment, sealing width W1 of the liquid crystal material injection port 3e and the injection port forming side 3a is 2.5 mm, while sealing width W2 of the three sides other than the injection port forming side 3a (3b through 3d) is 1.5 mm. The width of the part inside of the cutting line 4 in the liquid crystal material injection port 3e and the injection port forming side 3a is 1.5 mm, and accordingly, even if part of the sealing width of the liquid crystal material injection port 3e and the injection port forming side 3a is cut along the cutting line 4 (a liquid crystal material injection port 3e′ and an injection port forming side 3a′ shown in FIG. 3), a sealing width that is the same or substantially the same as that of the three sides 3b through 3d is secured.

Also, the width (1.0 mm) of the part outside of the cutting line 4 in the liquid crystal material injection port 3e and the injection port forming side 3a is smaller than the width (1.5 mm) of the inner part, reducing the amount of materials to be used as the sealing part 3.

It is also possible for the entire sealing part 3 to have a sealing width that is large enough to secure a sufficient sealing width even if the liquid crystal material injection port 3e and the injection port forming side 3a are cut (for example, 2.5 mm). However, this would lead to a large increase in the amount of materials to be used as the sealing part 3.

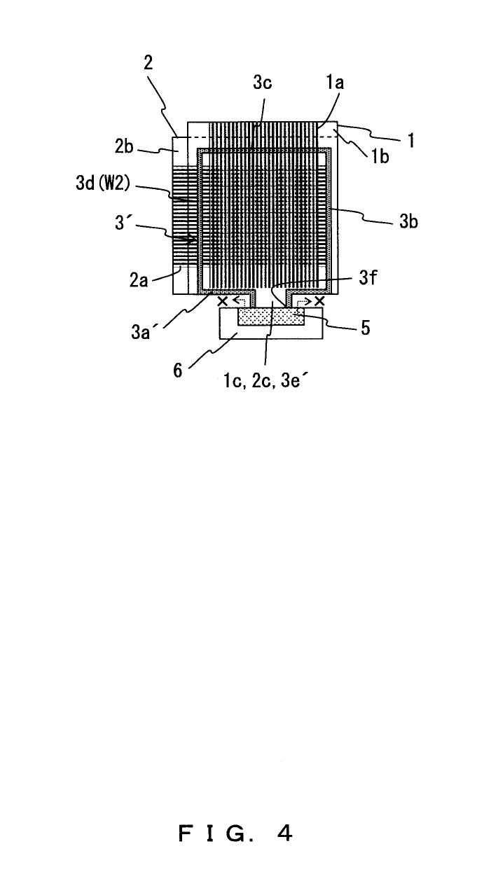

The sealing part 3 formed as above seals the liquid crystal material 5 shown in FIG. 4 between the first substrate 1 and the second substrate 2 shown in FIG. 3. In the present embodiment, the sealing part 3 is also used as an adhesive for fixing the connection between the first substrate 1 and the second substrate 2.

Next, when the first substrate 1 and the second substrate 2 are cut out into the shapes shown in FIG. 3, the first substrate 1 and the second substrate 2 are adhered to each other by using, for example, the above sealing part 3 in such a manner that transparent electrodes 1a and 2a are opposite to each other. Note that the second substrate 2 as well may be formed from, for example, a flexible transparent mother film made of plastic similarly to the mother film 10.

Thereafter, by using, for example, a Thomson die, die cutting is performed so as to form the first substrate 1 and the second substrate 2 into large rectangles (along the cutting line 4 having a projection part 4a as shown in FIG. 1) including an extending part 1b extending to the upper direction in FIG. 3 and an extending part 2b extending to the left in FIG. 3, respectively.

Thereby, the first substrate 1 and the second substrate 2 are cut out into rectangles having the outward projecting parts 1c and 2c, which are opposite to the liquid crystal material injection port 3e (substrate cutting step). Also, the sealing part 3 is formed by performing die cutting on part of the liquid crystal material injection port 3e and the injection port forming side 3a in the width direction along the cutting line 4.

It is also possible to cut out only the liquid crystal material injection port 3e by performing a die cutting process along the cutting line 4.

Thereafter, the left edge of the first substrate 1 in FIG. 3 is cut, and the upper edge of the second substrate 2 shown in FIG. 3 is also cut. Thereby, the first substrate 1 and the second substrate 2 are cut out into different-sized rectangles having the extending parts 1b and 2b extending in different directions. The extending parts 1b and 2b can be formed by making grooves along the cutting line by, for example, laser irradiation, and eliminating unnecessary parts.

Next, explanations will be given for the “liquid crystal injection step”, in which the liquid crystal material 5 is injected into the sealing part 3.

The first substrate 1 and the second substrate 2 adhered as shown in FIG. 3 are decompressed by a decompression unit (not shown) until the sealing part 3 becomes a vacuum, and the projection parts 1c and 2c are inserted into the liquid crystal material 5 of a liquid holding part 6 as shown in FIG. 4, and thereafter the decompression is cancelled. Thereby, the liquid crystal material 5 is injected into the sealing part 3 (liquid crystal injection step).

As described above, the injection port forming side 3a and the liquid crystal material injection port 3e of the sealing part 3 are located on peripheries of the first substrate 1 and the second substrate 2 because they are formed on the cutting line 4 and a portion of them is cut in the width direction. This prevents the liquid crystal material 5 from flowing from the liquid crystal material injection port 3e of the sealing part 3 to along the peripheries of the first substrate 1 and the second substrate 2.

After the liquid crystal material 5 has been injected into the sealing part 3, an appropriate process such as sealing the liquid crystal material 5 within the sealing part 3 is performed, in which a washing step of removing the liquid crystal material 5 that has flowed from the liquid crystal material injection port 3e of the sealing part 3 can be omitted because the liquid crystal material 5 has been prevented from flowing from the liquid crystal material injection port 3e of the sealing part 3. As described above, a film substrate that can be used as a liquid crystal panel made of a film can be produced.

The sealing part forming step in the above explained present embodiment forms the liquid crystal material injection port 3e of the sealing part 3 on the cutting line 4 in the substrate cutting step.

Accordingly, the liquid crystal material injection port 3e is located on peripheries of the first substrate 1 and the second substrate 2, reducing a space into which the liquid crystal material 5 flows after flowing along peripheries of the first substrate 1 and the second substrate 2.

Accordingly, the present embodiment can prevent the liquid crystal material 5 from flowing to portions around the sealing part 3 for sealing the liquid crystal material 5. Further, because the liquid crystal material 5 is prevented from flowing to such portions, it is possible to reduce the amount of material to be used as the liquid crystal material 5, to reduce the panel washing step, and to prevent corrosion and the like of the transparent electrodes 1a and 2a that would be caused by the flowing of the liquid crystal material 5 to such portions.

Also, according to the present embodiment, in the sealing part forming step, the liquid crystal material injection port 3e of the sealing part 3 and the injection port forming side 3a including the liquid crystal material injection port 3e (at least a portion extending to the liquid crystal material injection port 3e) are formed on the cutting line 4 of the substrate cutting step. Accordingly, the liquid crystal material injection port 3e and the injection port forming side 3a are located on peripheries of the first substrate 1 and the second substrate 2, making it possible to prevent the liquid crystal material 5 from flowing to portions around the sealing part 3 for sealing the liquid crystal material 5 more securely.

Also, in the present embodiment, sealing width W1 of the liquid crystal material injection port 3e is greater than sealing width W2 of the sides 3b through 3d, which are all the sides except for the injection port forming side 3a in the sealing part forming step. This makes it possible to secure the sealing width so as to prevent the unnecessary flowing of the liquid crystal material 5 even if part of the liquid crystal material injection port 3e in the width direction is cut in the substrate cutting step.

Also, according to the present embodiment, in the sealing part forming step, sealing width W1 of the injection port forming side 3a on the cutting line 4 is greater than sealing width W2 of the other sides, making it possible to prevent the unnecessary flowing of the liquid crystal material 5 more securely even if part of the injection port forming side 3a in the width direction is cut in the substrate cutting step.

Also, according to the present embodiment, the liquid crystal material injection port 3e of the sealing part 3 is cut out by die cutting along the cutting line 4 in the substrate cutting step. This makes it possible to cut out part of the liquid crystal material injection port 3e in the width direction along the cutting line 4 accurately, and thus to prevent an uneven sealing width of the liquid crystal material injection port 3e.

Also, according to the present embodiment, the liquid crystal material injection port 3e and the injection port forming side 3a (at least a portion extending to the liquid crystal material injection port 3e) of the sealing part 3 are cut out by die cutting along the cutting line 4. This makes it possible to cut out part of the liquid crystal material injection port 3e and the injection port forming side 3a in the width direction along the cutting line 4 accurately, and thus to prevent an uneven sealing width of the liquid crystal material injection port 3e.

Also, according to the present embodiment, the liquid crystal material injection port 3e is formed into a shape projecting outwards (a rectangle), making it possible to enhance the durability against variations in pressure occurring (during a heating process or the like) in the liquid crystal panel of a flexible film substrate.

What is claimed is:

1. A method of producing a film substrate, comprising:
forming a sealing part for sealing a liquid crystal material between a first substrate and a second substrate into a shape having an outward projecting liquid crystal material injection port of the sealing part; and
cutting the first substrate and the second substrate into a shape having outward projecting parts opposite to the liquid crystal material injection port, wherein:
the forming of the sealing part forms the liquid crystal material injection port of the sealing part on a cutting line of the cutting of the first substrate and the second substrate.

2. The method of producing a film substrate, according to claim 1, wherein:
the forming of the sealing part further forms, on the cutting line of the cutting the first substrate and the second substrate, a part that extends at least to the liquid crystal material injection port on an injection port forming side on which the liquid crystal material injection port is provided among sides formed in the sealing part.

3. The method of producing a film substrate according to claim 1, wherein:
in the forming of the sealing part, a sealing width of the liquid crystal material injection port is greater than a sealing width of sides other than the injection port forming side.

4. The method of producing a film substrate according to claim 1, wherein:
in the forming of the sealing part, a sealing width of the injection port forming side on the cutting line is greater than a sealing width of other sides.

5. The method of producing a film substrate according to claim 1, wherein:
in the cutting of the first substrate and the second substrate, the liquid crystal material injection port of the sealing part is cut out by die cutting along the cutting line.

6. The method of producing a film substrate according to claim 5, wherein:
the cutting of the first substrate and the second substrate further cuts apart that extends at least to the liquid crystal material injection port on the injection port forming side by die cutting along the cutting line.
